(19) United States
(12) Patent Application Publication
(10) Pub. No.: US 2002/0038460 A1
(43) Pub. Date: Mar. 28, 2002

(54) Electronic cinema system, distribution apparatus, and showing apparatus

(76) Inventor: Takayuki Kimoto, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/956,821

(22) Filed: Sep. 21, 2001

(30) Foreign Application Priority Data
Sep. 22, 2000 (JP) 2000-287843

(51) Int. Cl. H04N 7/167; H04N 7/173

(52) U.S. Cl. 725/109; 725/31; 725/105

(57) ABSTRACT

This invention relates to an electronic cinema system that electronically delivers movie software or distributes its recording medium to show the movie, and has for its object to provide an electronic cinema system, a distribution apparatus and a showing apparatus, which maintain the security of the whole system. Video is electronically delivered or a recording medium which contains the video is distributed to theaters, further captions and audio are transmitted using an internet protocol, and the video and the audio is synchronously played back in each theater as well as the video and the captions are synchronously played back, composed and shown.

### FIELD OF THE INVENTION

The present invention relates to an electronic cinema system, a distribution apparatus and a showing apparatus, for electronically delivering movie software or distributing a recording medium that contains data of the software, to show the movie.

### BACKGROUND OF THE INVENTION

From the latter half of the 1950s to the former half of the 1960s, there were about 7500 movie theaters in Japan and the movie industry occupied a position of the leading part in the Japanese video image industry. However, the movie industry thereafter surrendered the position to the television, and in recent years it has been greatly affected also by video rentals and the number of movie theaters in 1998 was only 1993.

On the other hand, in the U.S., as the movie theater facilities are rationalized, cinema-complex-type movie theaters have been newly founded. In these several years, the number of movie theaters is increased from about twenty-eight thousand to thirty thousand and the entire box-office profits are also increased.

Also in the Japanese movie industry, in order to put the brakes on the above-mentioned declining tendency, various measures such as rationalization of movie theater facilities, making the seats deluxe, and establishment of cinema complexes are taken, whereby the effects are showing up little by little.

While the movie world is in the aforementioned state, electronic cinema systems which project movies not using films but using videotapes have been seen in many places.

These conventional electronic cinema systems are not independent movie theaters but are joined with distribution companies and established in supermarkets, department stores or the like. This electronic cinema system has nearly 200 seats and the operation is completely automated. Distribution VCR tapes to be used in these video theaters are composed of blocks shown in FIG. 2, and played back.

Hereinafter, the conventional electronic cinema system will be described with reference to FIG. 9.

In FIG. 9, reference numeral 1 denotes a movie film. A telecine apparatus 2 has an optical/electrical converter 2a and a color compensator 2b. A master VCR 3 makes a master tape 4. A dubbing VCR 6 dubs the movie film onto a tape 7 to be distributed (hereinafter, referred to as distribution tape). A playback VCR 8 plays back the distribution tape 7. A theater control device 9 controls peripheral devices. Numeral 10 denotes a monitor. Numeral 11 denotes a projector.

Then, the operation of the conventional electronic cinema system will be described.

A movie film 1 is subjected to optical/electrical conversion and then to color compensation in the telecine apparatus 2, to enhance the color reproducibility of the video image. Then, a signal that has been subjected to telecine conversion is recorded to make a master tape 4. Many distribution tapes 7 are made from the master tape 4 using the DVCPRO format VCR 6, and distributed to theaters.

In each theater, the DVCPRO format VCR 8 is employed, several VCRs are input to the theater control device 9 to select video images to be shown, the selected video images are projected by the projector 11, and the same video images are displayed on the monitor 10.

As described above, it is possible that the movie film is subjected to the telecine conversion, the master tape is made, thereafter the master tape is dubbed onto the distribution VCR tapes, and the distribution tapes are distributed to theaters in various places and shown.

However, since the management of the distribution tapes distributed to the theaters is left to the theaters, the tapes are easily dubbed illegally, which may affect the video rental industry. Some videotapes are copyguarded, but in many of these a vertical synchronization signal in the video signal is subjected to a slight copy guard process and the video image part itself remains on the tape, whereby the videotapes can be relatively easily copied.

### SUMMARY OF THE INVENTION

It is an object of the present invention to provide an electronic cinema system, a distribution apparatus and a showing apparatus, for maintaining the security of movie software in the entire system.

Other objects and advantages of the present invention will become apparent from the detailed description and specific embodiments described are provided only for illustration since various additions and modifications within the spirit and scope of the invention will be apparent to those of skill in the art from the detailed description.

According to a 1st aspect of the present invention, there is provided an electronic cinema system which electronically delivers video of movie software or distributes a recording medium that contains the video, to show the movie, comprising: a distribution apparatus for transmitting captions of the movie software to a theater using an internet protocol; and a showing apparatus for composing the video and a caption corresponding to the video, and showing the composed video and caption. Therefore, it is possible to electronically deliver or distribute video from a distribution apparatus to a showing apparatus, transmit captions to the showing apparatus using the internet protocol, and compose the video and the captions in the showing apparatus to show the composed video and captions, thereby preventing unauthorized copying.

According to a 2nd aspect of the present invention, in the electronic cinema system of the 1st aspect, the distribution apparatus includes: a caption storage means for storing caption information corresponding to the video; a reading means for reading the caption information from the caption storage means; a copy protection device for subjecting the video to a copy protection process; a key management device for managing a key for releasing the copy protection process; and a transmission means for transmitting the key and the caption information using the internet protocol. Therefore, it is possible to separate and separately store video and captions on a distribution side and transmit the video and the captions separately to a showing apparatus, and further make captions in various languages for each video on the distribution side and transmit suitable captions to each showing apparatus.

According to a 3rd aspect of the present invention, in the electronic cinema system of the 1st aspect, the showing apparatus includes: a theater control device for composing the video and a caption corresponding to the video, and outputting the composed video and caption; and a projector for projecting the data outputted from the theater control device. Therefore, a showing apparatus can compose video and a caption corresponding to the video which have been received separately, and show the composed video and caption, thereby preventing unauthorized copying.

According to a 4th aspect of the present invention, in the electronic cinema system of the 3rd aspect, the theater control device includes: a selection means for selecting video to be shown among the received video; a storage means for storing the caption information, and outputting a caption corresponding to the video selected by the selection means; and a composition means for synchronously playing back the video selected by the selection means and the caption outputted from the storage means to compose the video and the caption, and outputting the composed video and caption. Therefore, the protection from the unauthorized copying can be further reinforced, thereby maintaining the security of the whole electronic cinema system.

According to a 5th aspect of the present invention, in the electronic cinema system of the 3rd aspect, the theater control device includes: a selection means for selecting video to be shown among the received video, and outputting the selected video; and a first storage means for storing the caption information, and outputting a caption corresponding to the video selected by the selection means, and the projector includes: a second storage means for storing the caption outputted from the first storage means; a composition means for synchronously playing back the video outputted from the selection means and the caption stored in the second storage means, and composing the video and the caption; and a projection means for projecting the composed video and caption. Therefore, the protection from the unauthorized copying can be further reinforced, thereby maintaining the security of the whole electronic cinema system.

According to a 6th aspect of the present invention, there is provided an electronic cinema system which electronically delivers video of movie software or distributes a recording medium that contains the video, to show the movie, comprising: a distribution apparatus for transmitting captions and audio of the movie software to a theater using an internet protocol; and a showing apparatus for synchronously playing back the video and audio corresponding to the video, and composing the video and a caption corresponding to the video to show the movie. Therefore, it is possible to electronically deliver or distribute video from a distribution apparatus to a showing apparatus, transmit captions and audio to the showing apparatus using the internet protocol, and synchronously play back the video and the audio in the showing apparatus as well as compose the video and the captions and show the composed video and captions, thereby preventing the unauthorized copying.

According to a 7th aspect of the present invention, in the electronic cinema system of the 6th aspect, the distribution apparatus includes: a caption storage means for storing caption and audio information corresponding to the video; a reading means for reading the caption and audio information from the caption storage means; a copy protection device for subjecting the video to a copy protection process; a key management device for managing a key for releasing the copy protection process; and a transmission means for transmitting the key and the caption and audio information using the internet protocol. Therefore, it is possible to make captions in various languages for each video and transmit suitable captions to each showing apparatus, as well as make audio of various kinds of Dolby, DTS and the like and transmit suitable audio to each showing apparatus, thereby improving sound environments of each showing apparatus.

According to an 8th aspect of the present invention, in the electronic cinema system of the 6th aspect, the showing apparatus includes: a theater control device for synchronously playing back the video and audio corresponding to the video as well as composing the video and a caption corresponding to the video, and outputting the composed video and caption; and a projector for projecting the data outputted from the theater control device. Therefore, the showing apparatus can synchronously play back video and audio corresponding to the video, which have been received separately, as well as compose the video and a caption corresponding to the video and show the composed video and caption, thereby preventing the unauthorized copying.

According to a 9th aspect of the present invention, in the electronic cinema system of the 8th aspect, the theater control device includes: a selection means for selecting video to be shown among the received video; a storage means for storing the caption and audio information, and outputting a caption and audio corresponding to the video selected by the selection means; a composition means for synchronously playing back the video selected by the selection means and the caption outputted from the storage means to compose the video and the caption, and outputting the composed video and caption; and a synchronous playback means for playing back the audio outputted from the storage means in synchronization with the video selected by the selection means Therefore, the protection from the unauthorized copying can be further reinforced, thereby maintaining the security of the whole electronic cinema system.

According to a 10th aspect of the present invention, in the electronic cinema system of the 8th aspect, the theater control device includes: a selection means for selecting video to be shown among the received video, and outputting the selected video; a first storage means for storing the caption and audio information, and outputting a caption and audio corresponding to the video selected by the selection means; and a synchronous playback means for playing back the audio outputted form the first storage means in synchronization with the video selected by the selection means, and the projector includes: a second storage means for storing the caption outputted from the first storage means; a composition means for synchronously playing back the video outputted from the selection means and the caption stored in the second storage means, and composing the video and the caption; and a projection means for projecting the composed video and caption. Therefore, the protection from the unauthorized copying can be further reinforced, thereby maintaining the security of the whole electronic cinema system.

According to an 11th aspect of the present invention, there is provided a distribution apparatus which electronically delivers video of movie software or distributes a recording medium that contains the video, comprising: a caption storage means for storing caption information corresponding to the video; a reading means for reading the caption information from the caption storage means; a copy protection device for subjecting the video to a copy protection process; a key management device for managing a key for releasing the copy protection process; and a transmission means for transmitting the key and the caption information using an internet protocol. Therefore, it is possible to separate and separately store video and captions on a distribution side and transmit the video and the captions separately to a showing apparatus, and further make captions in various languages for each video on the distribution side and transmit suitable captions to each showing apparatus.

According to a 12th aspect of the present invention, there is provided a distribution apparatus which electronically delivers video of movie software or distributes a recording medium that contains the video, comprising: a caption storage means for storing caption and audio information corresponding to the video; a reading means for reading the caption and audio information from the caption storage means; a copy protection device for subjecting the video to a copy protection process; a key management device for managing a key for releasing the copy protection process; and a transmission means for transmitting the key and the caption and audio information using an internet protocol. Therefore, it is possible to make captions in various languages for each video and transmit suitable captions to each showing apparatus, as well as make audio of various kinds of Dolby, DTS and the like and transmit suitable audio to each showing apparatus, thereby improving sound environments of each showing apparatus.

According to a 13th aspect of the present invention, there is provided a showing apparatus which separately receives video and captions of movie software, and shows the movie, comprising: a theater control device for composing the video and a caption corresponding to the video, and outputting the composed video and caption; and a projector for projecting the data outputted from the theater control device. Therefore, the showing apparatus can compose video and captions corresponding to the video, which have been received separately, to show the composed video and captions, thereby preventing the unauthorized copying.

According to a 14th aspect of the present invention, in the showing apparatus of the 13th aspect, the theater control device includes: a selection means for selecting video to be shown among the received video; a storage means for storing the caption information, and outputting a caption corresponding to the video selected by the selection means; and a composition means for synchronously playing back the video selected by the selection means and the caption outputted from the storage means to compose the video and the caption, and outputting the composed video and caption. Therefore, the protection from the unauthorized copying can be further reinforced, thereby maintaining the security of the whole electronic cinema system.

According to a 15th aspect of the present invention, in the showing apparatus of the 13th aspect, the theater control device includes: a selection means for selecting video to be shown among the received video, and outputting the selected video; and a first storage means for storing the caption information, and outputting a caption corresponding to the video selected by the selection means, and the projector includes: a second storage means for storing the caption outputted from the first storage means; a composition means for synchronously playing back the video outputted from the selection means and the caption stored in the second storage means, and composing the video and the caption; and a projection means for projecting the composed video and caption. Therefore, the protection from the unauthorized copying can be further reinforced, thereby maintaining the security of the whole electronic cinema system.

According to a 16th aspect of the present invention, there is provided a showing apparatus which separately receives video, captions and audio of movie software, and shows the movie, comprising: a theater control device for synchronously playing back the video and audio corresponding to the video as well as composing the video and a caption corresponding to the video and outputting the composed video and caption; and a projector for projecting the data outputted from the theater control device. Therefore, the showing apparatus can synchronously play back video and audio corresponding to the video, which have been received separately, as well as compose the video and a caption corresponding to the video and show the composed video and caption, thereby preventing the unauthorized copying.

According to a 17th aspect of the present invention, in the showing apparatus of the 16th aspect, the theater control device includes: a selection means for selecting video to be shown among the received video; a storage means for storing information of the captions and the audio, and outputting a caption and audio corresponding to the video selected by the selection means; a composition means for synchronously playing back the video selected by the selection means and the caption outputted from the storage means to compose the video and the caption, and outputting the composed video and caption; and a synchronous playback means for playing back the audio outputted from the storage means in synchronization with the video selected by the selection means. Therefore, the protection from the unauthorized copying can be further reinforced, thereby maintaining the security of the whole electronic cinema system.

According to an 18th aspect of the present invention, in the showing apparatus of the 16th aspect, the theater control device includes: a selection means for selecting video to be shown among the received video, and outputting the selected video; a first storage means for storing information of the captions and the audio, and outputting a caption and audio corresponding to the video selected by the selection means; and a synchronous playback means for playing back the audio outputted from the first storage means in synchronization with the video selected by the selection means, and the projector includes: a second storage means for storing the caption outputted from the first storage means; a composition means for synchronously playing back the video outputted from the selection means and the caption stored in the second storage means, and composing the video and the caption; and a projection means for projecting the composed video and caption. Therefore, the protection from the unauthorized copying can be further reinforced, thereby maintaining the security of the whole electronic cinema system.

### BRIEF DESCRIPTION OF THE DRAWINGS

FIG. 1 is a block diagram illustrating a structure of an electronic cinema system according to the present invention.

FIG. 2 is a diagram for showing a copy protection process for video images.

FIG. 3 is a block diagram illustrating a structure of a theater control device according to a first embodiment of the present invention.

FIG. 4 is a block diagram illustrating a structure of a projector according to the first or a third embodiment of the present invention.

FIG. 5 is a block diagram illustrating a structure of a theater control device according to a second embodiment of the present invention.

FIG. 6 is a block diagram illustrating a structure of a projector according to the second or a fourth embodiment of the present invention.

FIG. 7 is a block diagram illustrating a structure of a theater control device according to the third embodiment.

FIG. 8 is a block diagram illustrating a structure of a theater control device according to the fourth embodiment.

FIG. 9 is a block diagram illustrating a prior art electronic cinema system.

### DETAILED DESCRIPTION OF THE PREFERRED EMBODIMENTS

Hereinafter, embodiments of the present invention will be described with reference to the drawings. The embodiments shown here are merely examples and the present invention is not restricted to these embodiments.

[Embodiment 1]

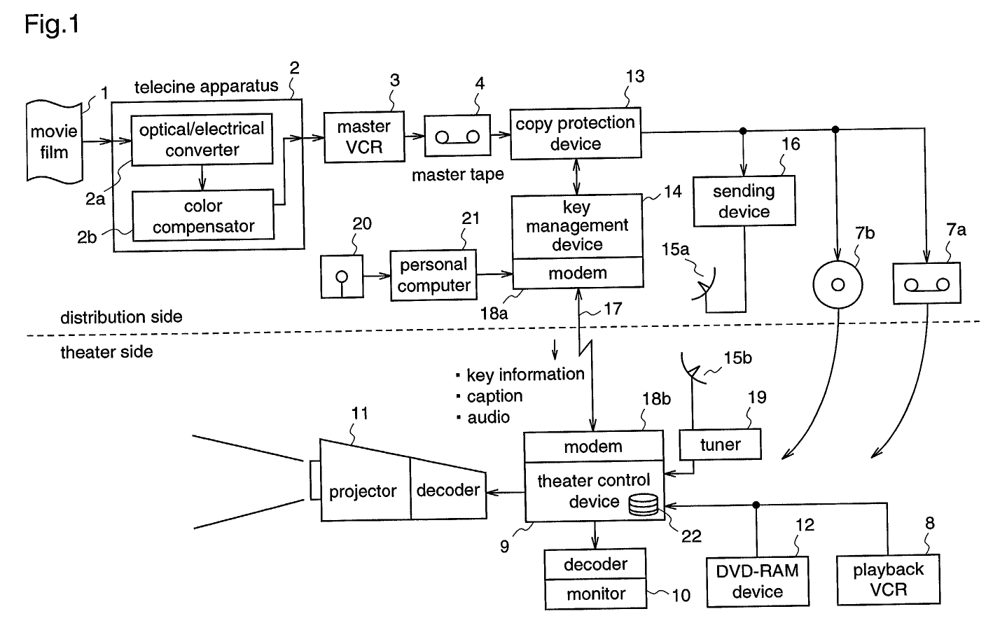

Hereinafter, an electronic cinema system according to a first embodiment of the present invention will be described with reference to FIGS. 1, 2, 3 and 4. Here, the electronic cinema system according to the first embodiment is an electronic cinema system which electronically delivers video of movie software or distributes a recording medium that contains the video and shows the video in a theater, in which captions in the movie software are transmitted to the theater using an internet protocol (hereinafter, referred to as IP), composes the video and a caption corresponding to the video in the theater, and shows the composed video and caption.

FIG. 1 is a block diagram illustrating a structure of an electronic cinema system according the first embodiment.

In FIG. 1, a part above the center dotted line is the distribution side and it shows processes until the electronic delivery of video or distribution of a recording medium which contains the video is performed. A part below the dotted line is the theater side and it shows processes until the video that has been electronically delivered or distributed from the distribution side is shown. Numeral 1 denotes a movie film. A telecine apparatus 2 performs optical/electrical conversion to the movie film 1 by means of an optical/electrical converter 2a, and thereafter performs color compensation by means of a color compensator 2b. A master VCR 3 records a telecine-converted signal to make a master tape 4. A playback VCR 8 plays back a distribution tape 7a. A theater control device 9 selects a video source. Further, the controller 9 includes a hard disk drive 22 that retains caption data transmitted using the IP. A monitor 10 displays the video selected by the theater control device 9. A projector 11 projects the video selected by the theater control device 9. Here, the monitor 10 and the projector 11 include a decoder, respectively. A DVD-RAM apparatus 12 plays back a DVD-RAM medium 7b. A copy protection device 13 subjects the master tape 4 to a copy protection process of line permutation, and records the video on the distribution tape 7a, the DVD-RAM medium 7b and a sending apparatus 16. A key management device 14 manages key information for decoding the copy protection. A sending antenna 15a transmits video data recorded on the sending apparatus 16 to the theater side. A modem 18 a transmits caption data and a caption timing signal to the theater side using the IP via a telephone line 17. A modem 18b outputs the caption data and the caption timing signal transmitted from the modem 18a to the theater control device 9. A tuner 19 encrypts the video data received from the distribution side via a receiving antenna 15b into an MPEG2-format video signal. A floppy disk 20 contains the caption data and the caption timing signal. A personal computer 21 reads the caption data and the timing signal stored in the floppy disk 20.

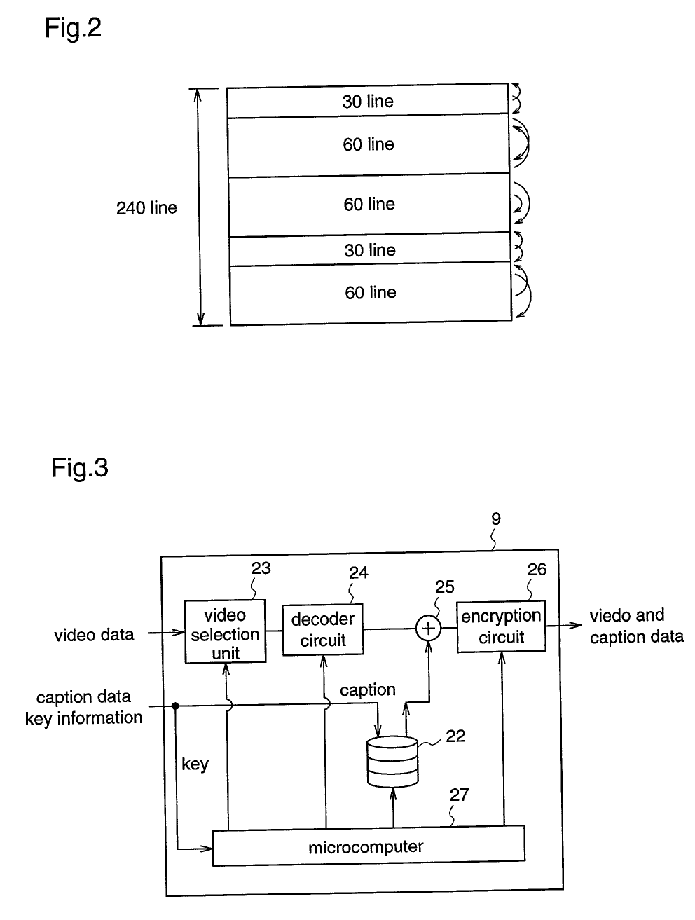

FIG. 2 is a diagram showing the copy protection process for the video data.

The line permutation for the master tape 4 is performed by deciding the effective screen of each field at 240 scan lines and dividing the same into blocks of 30 lines and 60 lines, as shown in FIG. 2. The generation of these two kinds of blocks is made at random as well as the scan lines in each block are made random, whereby it can be made difficult to decrypt the boundary of the blocks. The video signal which has been subjected to the copy protection process is a component signal of Y (luminance signal) and PB and Pr (color difference signals), and recorded on the distribution tape 7a or the distribution DVD-RAM medium 7b.

FIG. 3 is a diagram illustrating a structure of the theater control device 9 according to the first embodiment.

In FIG. 3, a hard disk drive 22 has a storage means that retains captions transmitted from the distribution side using the IP. A video selection unit 23 has a selection means for selecting video to be shown among videos which have been electronically delivered or distributed. A decoder circuit 24 decodes the video selected by the video selection unit 23. A composition unit 25 has a composition means for synchronously playing back the video decoded by the decoder circuit 24 and a caption corresponding to the video, and composing the video and the caption. An encryption circuit 26 encrypts the video and caption data composed by the composition unit 25, and outputs the encrypted data to the projector 11. A microcomputer 27 retains key information and controls the peripheral devices.

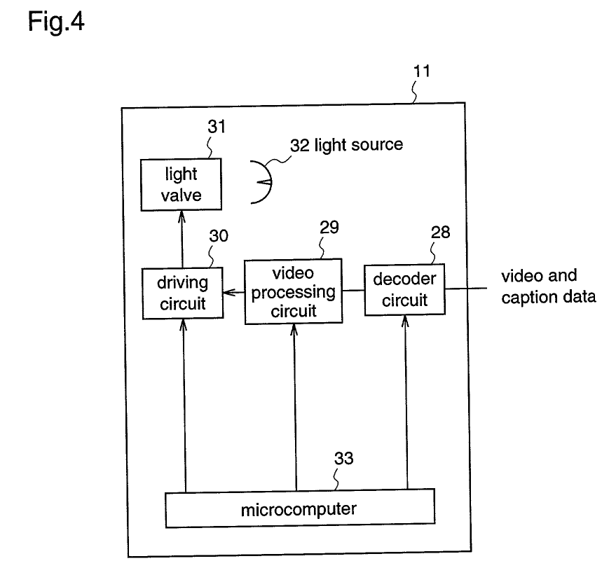

FIG. 4 is a block diagram illustrating a structure of the projector 11 according to the first embodiment. In FIG. 4, the projector 11 comprises a decoder circuit 28, a video processing circuit 29, a driving circuit 30, a light valve 31, a light source 32, and a microcomputer 33. The decoder circuit 28 decodes the video and caption which have been composed by the theater control device 9, to project the decoded video and caption.

Hereinafter, the electronic cinema system according to the first embodiment will be described.

On the distribution side, the movie film 1 is subjected to optical/electrical conversion by the optical/electrical converter 2a in the telecine apparatus 2 and thereafter subjected to color compensation by the color compensator 2b, to enhance the color reproducibility of video. Then, a signal telecine-converted by the master VCR 3 is recorded to make the master tape 4. The copy protection device 13 performs copy protection of line permutation to the master tape 4, records video data on the distribution tape 7a or the DVD-RAM medium 7b, and distributes the tape or medium to each theater. Or the apparatus 13 records video data which has been subjected to the copy protection on the sending apparatus 16, to electrically deliver the video data to each theater with utilizing a communication satellite.

The key information that is required for decoding the copy protection is managed by the key management device 14.

The caption data and the timing signal which are recorded on the floppy disk 20 are read by the personal computer 21, and the caption data and the caption timing signal are transmitted to the theater control device 9 via the modems 18a and 18b using the IP. Here, on the distribution side, it is possible to make captions in various languages for each video and transmit a caption which is suitable for each theater.

On the theater side, the playback VCR 8 and the DVD-RAM apparatus 12 which are connected to an IEEE1394 secure bus are controlled by the theater control device 9. The video data which are received by the tuner 19 via the receiving antenna 15b are encrypted into an MPEG2-format video signal, and inputted to the theater control device 9. The caption data transmitted from the distribution side using the IP is stored in the hard disk drive 22 in the theater control device 9. The theater control device 9 selects a video source, decides video to be shown, and composes the video with a caption corresponding to the video to be shown among the stored captions. The theater control device 9 has two SDI outputs and two IEEE1394 terminals, which are connected to the projector 11 and the monitor 10, respectively, and thereby the composed video and caption are shown. As described above, the video and captions are separately stored, the video is electronically delivered or distributed, and the captions are transmitted, whereby the unauthorized copying can be prevented. Further, since the video and captions of movie software are separated, it is only required to prepare captions in various languages alone, and thus there is no necessity to make a DVD or VCR tape on which video and captions are recorded according to language, whereby the costs can be reduced.

Here, since the video is subjected to the copy protection, the decoding with a decryption key should be performed. The key information is recorded to the theater control device 9 via the modem 18b, and authentication is performed by the theater control device 9 at the time of showing, to release the copy protection. However, when the security is to be further ensured, it is also possible that the theater control device 9 accesses the key management device 14 on the distribution side at the time of showing, so that the key management device 14 authenticates the projector 11 and the monitor 10.

Next, a method for composing video with a caption corresponding to the video in the theater control device 9 will be described.

As shown in FIG. 3, the theater control device 9 includes a hard disk drive 22 that is controlled by the microcomputer 27, and retains caption data and a caption timing signal which are transmitted via the modem 18b. The DVD-RAM apparatus 12, the playback VCR 8 and the like are controlled by the microcomputer 27 for playing back video, and the video selection unit 23 selects video to be shown. Then, the selected video data is decoded by the decoder circuit 24. Further, among the stored caption data, a caption corresponding to the video to be shown is outputted from the hard disk drive 22, and at this time the timing signal in the had disk drive 22 is managed, thereby playing back the outputted caption in synchronization with the video to be shown and composing the video with the caption in the composition unit 25 (OR circuit). Then, the composed video and caption are encrypted by the encryption circuit 26, and then outputted to the projector 11 and the monitor 10. Then, the projector 11 having a structure as shown in FIG. 4 projects the video and caption outputted from the theater control device 9. Further, the monitor 10 displays the video and caption outputted from the theater control device 9.

In this first embodiment, the DVD-RAM apparatus 12 is used as the recording/playback apparatus, while the present invention is not restricted to this and the same effect can be obtained by any VCR such as a DVCPRO-VCR and a D-VHS.

As described above, according to the electronic cinema system of the first embodiment, the theater control device and the projector are provided in the theater. The theater control device includes a selection means for selecting video to be shown among video that has been electronically delivered or distributed, a storage means for storing captions transmitted using the internet protocol (IP) and outputting a caption corresponding to the video, and a composition means for synchronously playing back the selected video and the caption corresponding to the video and composing the video and the caption, whereby the composed video and caption are outputted to the projector, and the projector projects the video and caption outputted from the theater control device. Accordingly, on the distribution side, the video and the captions are separated and stored separately and the video and the captions are composed by the theater control device in the theater. Therefore, the unauthorized copying can be prevented, whereby the security in the whole electronic cinema system can be maintained. Further, on the distribution side, it is possible to make captions in various languages corresponding to each video and transmit and show a caption suitable for each theater.

[Embodiment 2]

Hereinafter, an electronic cinema system according to a second embodiment of the present invention will be described with reference to FIGS. 1, 5 and 6.

According to the electronic cinema system of the second embodiment, in an electronic cinema system for electronically delivering video of movie software or distributing a recording medium which contains the video to show the movie, captions of the movie software are transmitted using the internet protocol and the video and captions corresponding to the video are composed and shown in the theater.

The structure of the electronic cinema system according to the second embodiment is almost the same as that in the first embodiment and thus descriptions of common elements are not given here. The difference from the first embodiment is that in the first embodiment video and captions are composed in the theater control device 9, while in the second embodiment video and captions are composed in the projector 11.

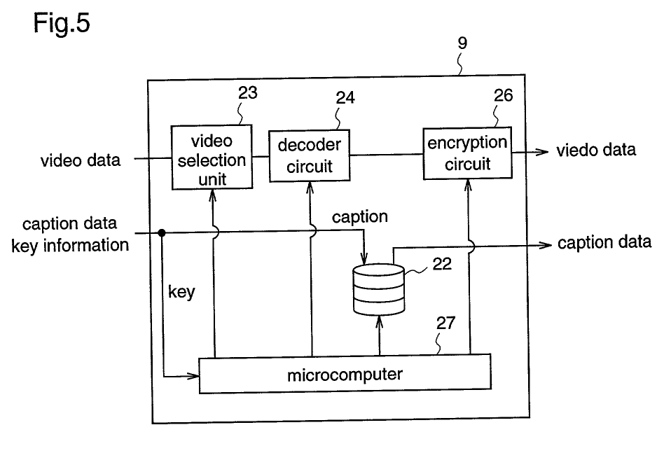

FIG. 5 is a block diagram illustrating the structure of the theater control device 9 according to the second embodiment.

In FIG. 5, a hard disk drive 22 has a storage means for storing captions transmitted from the distribution side by using an internet protocol (IP), and outputs a caption corresponding to video that has been selected by a video selection unit 23 to a projector 11. The video selection unit 23 has a selection means for selecting video to be shown among video that has been electronically delivered or distributed. A decoder circuit 24 decodes the video selected by the video selection unit 23. An encryption circuit 26 encrypts video that has been decoded by the decoder circuit 24 and outputs the encrypted video to the projector 11. A microcomputer 27 retains key information and controls peripheral devices.

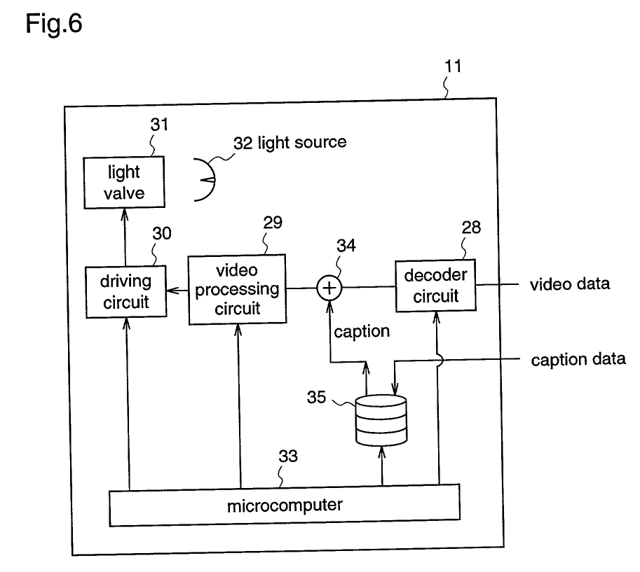

FIG. 6 is a block diagram illustrating a structure of the projector 11 according to the second embodiment. In FIG. 6, the projector 11 comprises a decoder circuit 28, a video processing circuit 29, a driving circuit 30, a light valve 31, a microcomputer 33, a composition unit 34 and a hard disk drive 35. The decoder circuit 28 decodes video data to be shown that is selected by the theater control device 9. The composition unit 34 has a composition means for synchronously playing back the video that has been decoded by the decoder circuit 28 and a caption corresponding to the video, and composing the video and the caption. The hard disk drive 35 has a storage means for storing captions outputted from the theater control device 9.

Hereinafter, the operation of the electronic cinema system according to the second embodiment will be described.

On the distribution side, video is electronically delivered or a recording medium which contains the video is distributed. Caption data and a caption timing signal is transmitted using the IP.

On the theater side, in the theater control device 9, video to be shown is selected by the video selection unit 23 among video that has been electronically delivered or distributed. Then, the selected video is decoded by the decoder circuit 24, encrypted by the encryption circuit 26, and outputted to the projector 11. Further, caption data that has been transmitted from the distribution side using the IP is stored in the hard disk drive 22. Then, among the stored caption data, a caption corresponding to the video selected by the video selection unit 23 is outputted to the projector 11.

Then, in the projector 11, the video outputted from the theater control device 9 is decoded by the decoder circuit 28. The caption outputted from the theater control device 9 is stored in the hard disk drive 35. Then, the video decoded by the decoder circuit 28 and the caption stored in the hard disk drive 35 are synchronously played back, composed by the composition unit 32, and then projected. As described above, the video and the caption are composed by the projector that finally performs the projection in the theater, whereby the copy protection can be further reinforced.

As described above, according to the electronic cinema system of the second embodiment, the theater control device and the projector are provided in the theater. The theater control device includes a selection means for selecting video to be shown among video that has been electronically delivered or distributed, and a storage means for storing captions transmitted using the IP and outputting a caption corresponding to the video, whereby the selected video and the caption corresponding to the video are outputted to the projector, respectively. Further, the projector includes a storage means for storing the caption outputted from the theater control device, and a composition means for synchronously playing back the video outputted from the theater control device and the stored caption and composing the video and the caption, thereby projecting the composed video and caption. Accordingly, on the distribution side, video and captions are separated and stored separately, and the video and the captions are composed by the projector that finally performs the projection in the theater. Therefore, the protection from the unauthorized copying is further reinforced, whereby the security of the whole electronic cinema system can be maintained. Further, on the distribution side, it is possible to make captions in various languages corresponding to each video, and transmit and show captions suitable for each theater.

[Embodiment 3]

Hereinafter, an electronic cinema system according to a third embodiment of the present invention will be described with reference to FIGS. 1, 4 and 7.

According to the electronic cinema system of the third embodiment, in an electronic cinema system that electronically delivers video of movie software or distributes a recording medium which contains the video to show the movie in a theater, captions and audio of the movie software are transmitted to the theater using an internet protocol (IP), the video and a caption corresponding to the video are composed in the theater, and audio corresponding to the video is synchronously played back to be shown.

Here, the structure of the electronic cinema system according to the third embodiment is almost the same as that in the first embodiment, and thus descriptions of common elements are not given here. The difference from the first embodiment is that in the first embodiment video and captions are separately stored, the video is electronically delivered or distributed, and the captions are transmitted using the IP, while in the third embodiment video, captions and audio are separately stored, the video is electronically delivered or distributed, and the captions and audio are transmitted using the IP.

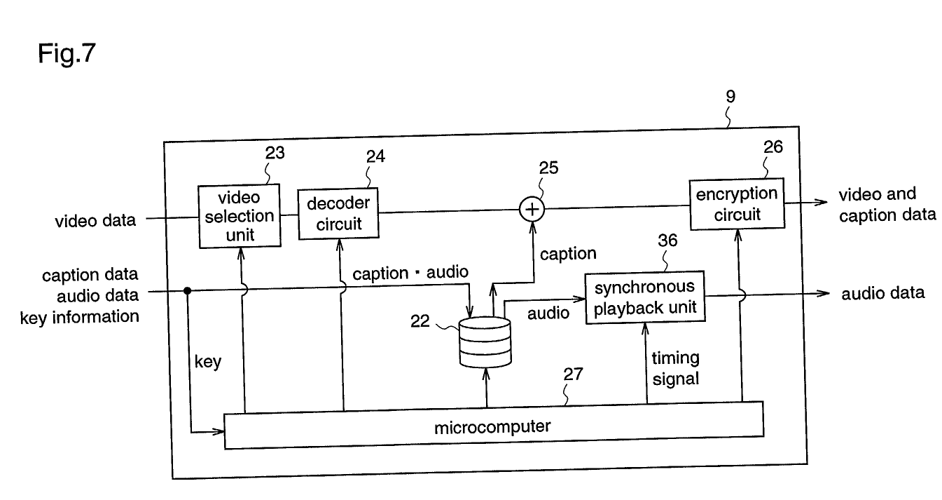

FIG. 7 is a block diagram illustrating a structure of a theater control device 9 according to the third embodiment. In FIG. 7, a hard disk drive 22 has a storage means for storing captions and audio transmitted from the distribution side using the IP. A video selection unit 23 has a selection means for selecting video to be shown among video that has been electronically delivered or distributed. A decoder circuit 24 decodes the video selected by the video selection unit 23. A composition unit 25 has a composition means for synchronously playing back the video decoded by the decoder circuit 24 and a caption corresponding to the video, and composing the video and the caption. An encryption circuit 26 encrypts the video and caption composed by the composition unit 25 and outputting the encrypted video and caption to the projector 11. A microcomputer 27 retains key information and controls the peripheral devices. A synchronous playback unit 36 has a synchronous playback means for playing back audio corresponding to the video selected by the video selection unit 23 in synchronization with the selected video.

Hereinafter, the operation of the electronic cinema system according to the third embodiment will be described.

On the distribution side, video is electronically delivered or a recording medium which contains the video is distributed. Caption data, a caption timing signal, audio data and an audio timing signal are transmitted to the theater control device 9 via the modems 18a and 18b. On the distribution side, it is possible to make captions in various languages for each video and transmit a suitable caption to each theater. Further, it is possible to make audio of various kinds of Dolby, DTS and the like for each video and transmit suitable audio to each theater, thereby improving sound environments of each theater.

On the theater side, video data that has been electronically distributed from the distribution side by a communication satellite is received by the tuner 19 via the receiving antenna 15b, encrypted into an MPEG2-format video signal, and thereafter written in the DVD-RAM apparatus 12 for a while. Then, since the video data has been subjected to the copy protection process as shown in FIG. 2, the key management device 14 transmits authentication information as to whether the processed video can be written on the DVD-RAM medium 7b, via the modems 18a and 18b. The distributed distribution tape 7a and DVD-RAM medium 7b are played back by the playback VCR 8 and the DVD-RAM apparatus 12, respectively, and the theater control device 9 selects a video source. The transmitted caption data, caption timing signal, audio data and audio timing signal are stored in the hard disk drive 22 in the theater control device 9.

At the time of showing, the microcomputer 27 in the theater control device 9 performs control for playing back the video to be shown, and manages the audio timing signal and the caption timing signal in the hard disk drive 22 so that the synchronous playback unit 36 synchronously plays back audio corresponding to the video to be shown as well as the composition unit 25 (OR circuit) composes the video to be shown and a caption corresponding to the video. The composed video and caption are encrypted by the encryption circuit 26 and outputted to the projector 11 and the monitor 10. The projector 11 and the monitor 10 have a decoder, respectively, and decode the encrypted video and caption, thereby showing the video and caption. As described above, video, captions and audio are separately stored, the video is electronically delivered or distributed, the captions and the audio are transmitted using the IP, the video and the audio is synchronously played back in the theater, and the video and the captions are composed and shown, whereby the most solid copy protection can be realized.

As described above, according to the electronic cinema system of the third embodiment, the theater control device and the projector are provided in the theater. The theater control device has a selection means for selecting video to be shown among video that has been electronically delivered or distributed; a storage means for storing captions and audio transmitted using the IP; a composition means for synchronously playing back the video and a caption corresponding to the video and composing the video and the caption; and a synchronous playback means for playing back audio corresponding to the selected video in synchronization with the selected video, and outputs the composed video and caption to the projector, and the projector projects the video and caption outputted from the theater control device. Accordingly, on the distribution side, video, captions and audio are separated and stored separately, the video is electronically delivered or distributed, the caption and the audio are transmitted, the video and the audio is synchronously played back by the theater control device in the theater, as well as the video and the captions are composed and shown. Therefore, the protection from the unauthorized copying is further reinforced and the security of the whole electronic cinema system can be maintained. Further, it is required to make captions and audio in various languages corresponding to each video, while it is only required to dub each video, whereby the costs can be reduced. Further, on the distribution side, it is possible to make captions in various languages for each video and transmit a suitable caption to each theater, as well as make audio of various kinds of Dolby, DTS and the like for each video and transmit suitable audio to each theater, thereby improving sound environments in each theater.

[Embodiment 4]

Hereinafter, an electronic cinema system according to a fourth embodiment of the present invention will be described with reference to FIGS. 1, 6 and 8.

According to the electronic cinema system of the fourth embodiment, in an electronic cinema system that electronically delivers video of movie software or distributes a recording medium which contains the video to show the movie in a theater, captions and audio of the movie software are transmitted to the theater using an internet protocol (IP), the video and a caption corresponding to the video are composed in the theater, and audio corresponding to the video is synchronously played back to show the movie.

The structure of the electronic cinema system according to the fourth embodiment is almost the same as that in the second embodiment, and thus descriptions of common elements are not given here. The difference from the second embodiment is that in the second embodiment video and captions are stored separately on the distribution side, the video is electronically delivered or distributed, the captions are transmitted using the IP, and the video and the captions are composed in the theater, while in the fourth embodiment video, captions and audio are stored separately on the distribution side, the video is electronically delivered or distributed to the theater, the captions and the audio are transmitted to the theater using the IP, and the video and the audio is synchronously played back as well as the video and the captions are composed and shown in the theater. Further, the difference from the third embodiment is that in the third embodiment the video and the captions are composed in the theater control device 9, while in this fourth embodiment the video and the captions are composed in the projector 11.

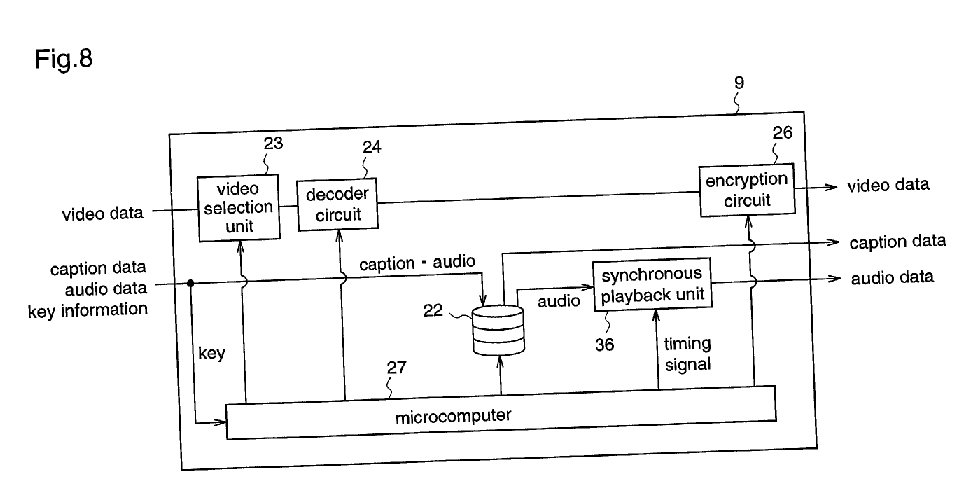

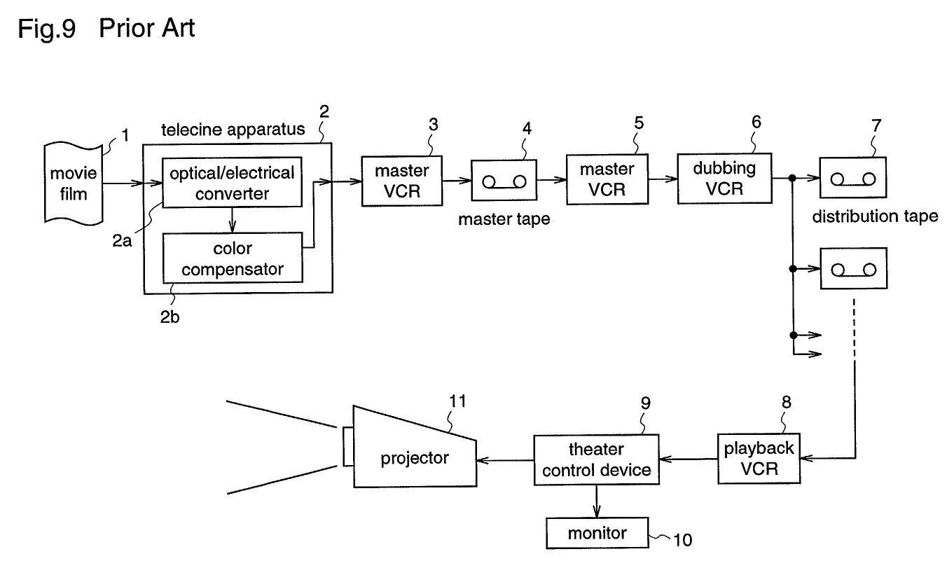

FIG. 8 is a block diagram illustrating a structure of a theater control device 9 according to this fourth embodiment. In FIG. 8, a hard disk drive 22 has a storage means for storing captions and audio transmitted from the distribution side using the internet protocol (IP). A video selection unit 23 has a selection means for selecting video to be shown among video that has been electronically delivered or distributed. A decoder circuit 24 decodes the video selected by the video selection unit 23. An encryption circuit 26 encrypts the video decoded by the decoder circuit 24 and outputs the decoded video to the projector 11. A microcomputer 27 retains key information and controls the peripheral devices. A synchronous playback unit 36 has a synchronous playback means for playing back audio corresponding to the video selected by the video selection unit 23 in synchronization with the selected video.

Hereinafter, the operation of the electronic cinema system according to the fourth embodiment will be described.

On the distribution side, video is electronically delivered or a recording medium that contains the video is distributed. Caption data, a caption timing signal, audio data and an audio timing signal are transmitted from the distribution side to each theater via the modems 18a and 18b.

On the theater side, among the video that has been electronically delivered or distributed from the distribution side, video to be shown is selected by the video selection unit 23 in the theater control device 9. The selected video is decoded by the decoder circuit 24, encrypted by the encryption circuit 26, and outputted to the projector 11 and the monitor 10. The transmitted caption data, caption timing signal, audio data and audio timing signal are stored in the hard disk drive 22 in the theater control device 9. Then, among the audio data stored in the hard disk drive 22, audio corresponding to the video selected by the video selection unit 23 is outputted to the synchronous playback unit 36, and the audio corresponding to the video is played back by the synchronous playback unit 36 in synchronization with the selected video. In addition, among the captions stored in the hard disk drive 22, a caption corresponding to the video selected by the video selection unit 23 is outputted to the projector 11. Then, the video outputted from the theater control device 9 and the caption corresponding to the video are synchronously played back and composed in the projector 11 as shown in FIG. 6, and then projected. As described above, video is electronically delivered or distributed, captions and audio are transmitted using the IP, and the video and the caption are not composed before reaching to the projector that finally performs the projection in the theater, whereby the most solid copy protection can be achieved, as well as audio suitable for the theater such as various kinds of Dolby and DTS can be distributed.

As described above, in the electronic cinema system according to the fourth embodiment, the theater control device and the projector are provided in the theater. The theater control device has a selection means for selecting video to be shown among video that has been electronically delivered or distributed; a storage means for storing captions and audio transmitted using the IP; and the synchronous playback means for playing back audio corresponding to the selected video in synchronization with the video, thereby outputting the selected video and a caption corresponding to the video to the projector. Further, the projector has a storage means for storing the caption outputted from the theater control device, and a composition means for synchronously playing back the video outputted from the theater control device and the store caption and composing the video and the caption, thereby projecting the composed video and caption. Thus, on the distribution side, video, captions and audio are separated and stored separately, the video and the audio is synchronously played back by the theater control device in the theater, and the video and the caption are composed and shown by the projector that finally performs the projection. Therefore, the protection from unauthorized copying can be mostly reinforced, thereby maintaining the security of the whole electronic cinema system. Further, on the distribution side, it is possible to make audio of various kinds of Dolby, DTS and the like for each video and transmit suitable audio to each theater, thereby improving sound environments in each theater.

What is claimed is:

1. An electronic cinema system which electronically delivers video of movie software or distributes a recording medium that contains the video, to show the movie, comprising:
a distribution apparatus for transmitting captions of the movie software to a theater using an internet protocol; and
a showing apparatus for composing the video and a caption corresponding to the video, and showing the composed video and caption.

2. The electronic cinema system of claim 1 wherein
the distribution apparatus includes:
a caption storage means for storing caption information corresponding to the video; a reading means for reading the caption information from the caption storage means; a copy protection device for subjecting the video to a copy protection process; a key management device for managing a key for releasing the copy protection process; and a transmission means for transmitting the key and the caption information using the internet protocol.

3. The electronic cinema system of claim 1 wherein
the showing apparatus includes:
a theater control device for composing the video and a caption corresponding to the video, and outputting the composed video and caption; and a projector for projecting the data outputted from the theater control device.

4. The electronic cinema system of claim 3 wherein
the theater control device includes:
a selection means for selecting video to be shown among the received video; a storage means for storing the caption information, and outputting a caption corresponding to the video selected by the selection means; and a composition means for synchronously playing back the video selected by the selection means and the caption outputted from the storage means to compose the video and the caption, and outputting the composed video and caption.

5. The electronic cinema system of claim 3 wherein
the theater control device includes:
a selection means for selecting video to be shown among the received video, and outputting the selected video; and a first storage means for storing the caption information, and outputting a caption corresponding to the video selected by the selection means, and
the projector includes:
a second storage means for storing the caption outputted from the first storage means; a composition means for synchronously playing back the video outputted from the selection means and the caption stored in the second storage means, and composing the video and the caption; and a projection means for projecting the composed video and caption.

6. An electronic cinema system which electronically delivers video of movie software or distributes a recording medium that contains the video, to show the movie, comprising:
a distribution apparatus for transmitting captions and audio of the movie software to a theater using an internet protocol; and
a showing apparatus for synchronously playing back the video and audio corresponding to the video, and composing the video and a caption corresponding to the video to show the movie.

7. The electronic cinema system of claim 6 wherein
the distribution apparatus includes:
a caption storage means for storing caption and audio information corresponding to the video; a reading means for reading the caption and audio information from the caption storage means; a copy protection device for subjecting the video to a copy protection process; a key management device for managing a key for releasing the copy protection process; and a transmission means for transmitting the key and the caption and audio information using the internet protocol.

8. The electronic cinema system of claim 6 wherein
the showing apparatus includes:
a theater control device for synchronously playing back the video and audio corresponding to the video as well as composing the video and a caption corresponding to the video, and outputting the composed video and caption; and a projector for projecting the data outputted from the theater control device.

9. The electronic cinema system of claim 8 wherein
the theater control device includes:
a selection means for selecting video to be shown among the received video; a storage means for storing the caption and audio information, and outputting a caption and audio corresponding to the video selected by the selection means; a composition means for synchronously playing back the video selected by the selection means and the caption outputted from the storage means to compose the video and the caption, and outputting the composed video and caption; and a synchronous playback means for playing back the audio outputted from the storage means in synchronization with the video selected by the selection means.

10. The electronic cinema system of claim 8 wherein
the theater control device includes:
a selection means for selecting video to be shown among the received video, and outputting the selected video; a first storage means for storing the caption and audio information, and outputting a caption and audio corresponding to the video selected by the selection means; and a synchronous playback means for playing back the audio outputted form the first storage means in synchronization with the video selected by the selection means, and
the projector includes:
a second storage means for storing the caption outputted from the first storage means; a composition means for synchronously playing back the video outputted from the selection means and the caption stored in the second storage means, and composing the video and the caption; and a projection means for projecting the composed video and caption.

11. A distribution apparatus which electronically delivers video of movie software or distributes a recording medium that contains the video, comprising:
a caption storage means for storing caption information corresponding to the video;
a reading means for reading the caption information from the caption storage means;
a copy protection device for subjecting the video to a copy protection process;
a key management device for managing a key for releasing the copy protection process; and
a transmission means for transmitting the key and the caption information using an internet protocol.

12. A distribution apparatus which electronically delivers video of movie software or distributes a recording medium that contains the video, comprising:
a caption storage means for storing caption and audio information corresponding to the video;
a reading means for reading the caption and audio information from the caption storage means;
a copy protection device for subjecting the video to a copy protection process;
a key management device for managing a key for releasing the copy protection process; and
a transmission means for transmitting the key and the caption and audio information using an internet protocol.

13. A showing apparatus which separately receives video and captions of movie software, and shows the movie, comprising:
a theater control device for composing the video and a caption corresponding to the video, and outputting the composed video and caption; and
a projector for projecting the data outputted from the theater control device.

14. The showing apparatus of claim 13 wherein
the theater control device includes:
a selection means for selecting video to be shown among the received video; a storage means for storing the caption information, and outputting a caption corresponding to the video selected by the selection means; and a composition means for synchronously playing back the video selected by the selection means and the caption outputted from the storage means to compose the video and the caption, and outputting the composed video and caption.

15. The showing apparatus of claim 13 wherein
the theater control device includes:
a selection means for selecting video to be shown among the received video, and outputting the selected video; and a first storage means for storing the caption information, and outputting a caption corresponding to the video selected by the selection means, and
the projector includes:
a second storage means for storing the caption outputted from the first storage means; a composition means for synchronously playing back the video outputted from the selection means and the caption stored in the second storage means, and composing the video and the caption; and a projection means for projecting the composed video and caption.

16. A showing apparatus which separately receives video, captions and audio of movie software, and shows the movie, comprising:
a theater control device for synchronously playing back the video and audio corresponding to the video as well as composing the video and a caption corresponding to the video and outputting the composed video and caption; and
a projector for projecting the data outputted from the theater control device.

17. The showing apparatus of claim 16 wherein
the theater control device includes:
a selection means for selecting video to be shown among the received video; a storage means for storing information of the captions and the audio, and outputting a caption and audio corresponding to the video selected by the selection means; a composition means for synchronously playing back the video selected by the selection means and the caption outputted from the storage means to compose the video and the caption, and outputting the composed video and caption; and a synchronous playback means for playing back the audio outputted from the storage means in synchronization with the video selected by the selection means.

18. The showing apparatus of claim 16 wherein
the theater control device includes:
a selection means for selecting video to be shown among the received video, and outputting the selected video; a first storage means for storing information of the captions and the audio, and outputting a caption and audio corresponding to the video selected by the selection means; and a synchronous playback means for playing back the audio outputted from the first storage means in synchronization with the video selected by the selection means, and
the projector includes:
a second storage means for storing the caption outputted from the first storage means; a composition means for synchronously playing back the video outputted from the selection means and the caption stored in the second storage means, and composing the video and the caption; and a projection means for projecting the composed video and caption.
